(19) United States
(12) Patent Application Publication
(10) Pub. No.: US 2002/0011085 A1
(43) Pub. Date: Jan. 31, 2002

(54) ANTI-SHOCK MECHANISM FOR AN ELECTRONIC LOCK

(76) Inventors: LARRY J. RICE, NICHOLASVILLE, KY (US); THOMAS H. RICHARDS, LEXINGTON, KY (US)

Correspondence Address: ARENT FOX KINTNER PLOTKIN & KAHN PLLC, 1050 CONNECTICUT AVENUE, N.W., SUITE 600, WASHINGTON, DC, 20036-5339, US

(21) Appl. No.: 09/435,799

(22) Filed: Nov. 8, 1999

Related U.S. Application Data
(60) Provisional application No. 60/108,301, filed on Nov. 13, 1998.

(51) Int. Cl. E05B 67/36

(52) U.S. Cl. 70/33

(57) ABSTRACT

The present anti-shock mechanism for an electronic lock is designed to limit displacement of the solenoid plunger when an external force acts on the lock case of an electronic lock. An external force, such as that created by a translating actuator, applied in a horizontal direction parallel to the direction of plunger motion may cause the solenoid plunger to displace allowing the lock to be opened without authorization. The addition of a properly sized anti-shock mechanism limits displacement of the solenoid plunger due to an external force or impact and allows movement of the solenoid plunger when the solenoid plunger movement is due to an authorized access. Under normal operating conditions when the lock is locked, the bolt is in the fully extended position and the solenoid is not actuated. Upon authorization, the solenoid actuates causing the mechanical components to be placed in a condition whereby the operator may open the lock. When the lock is subjected to a force or impact, the anti-shock bellcrank moves or rotates to a position that will limit the plunger's movement and prevent the mechanical components of the lock from being placed in positions that would permit the lock to be opened.

### BACKGROUND

1. Field of the Invention

This invention relates to the field of electronic locks and specifically to an antishock mechanism that prevents unauthorized lock break-ins occurring when an external force is applied to the lock displacing a solenoid plunger within the lock.

2. Description of the Related Art

Items of extremely sensitive nature or very high importance must be stored securely in a safe or other containment device, with access restricted to select individuals given a predetermined combination, code, or key access necessary to enable authorized entry. It is essential to ensure that unauthorized entry by persons employing safecracking techniques including use of a translating actuator is prevented.

Electronic locks including combination and key entry locks are commonly used to secure safes and other containment devices. Numerous locking mechanisms are known which employ various combinations of electrical, mechanical and magnetic elements both to ensure against unauthorized entry and to effect cooperative movements among the elements for authorized locking and unlocking operations.

Electric/electronic locks often contain a solenoid that is used to place the mechanical portions of the lock in a position where the operator may open the lock. Such solenoids often contain a plunger that pushes a lever or sliding bar. Some safes and security containers are built such that an external force or impact can be applied to the safe or security containers and as a result to the lock. Thus, this force or impact may cause the solenoid plunger to place the mechanical portions of the lock in a condition to open. Therefore, allowing unauthorized access to the secured items.

### SUMMARY OF THE INVENTION

The present invention solves the problem discussed above and is a mechanism designed to limit displacement of the solenoid plunger when an external force acts on the lock case of an electronic lock. An external force, such as that created by a translating actuator, applied in a direction parallel to the direction of solenoid plunger movement in a lock may cause the solenoid plunger in the lock to displace allowing the lock to be opened without authorization. The addition of a properly sized anti-shock mechanism limits displacement of the solenoid plunger due to an external force or impact and allows movement of the solenoid plunger when the solenoid plunger movement is due to an authorized access.

Under normal operating conditions when the lock is locked, the bolt is in the filly extended position and the solenoid is not actuated. Upon authorization, the solenoid actuates causing the mechanical components to be placed in a condition whereby the operator may open the lock. An anti-shock belcrank limits the solenoid plunger's travel and prevents the solenoid plunger from actuating the mechanical portions of the lock upon application of an external force upon the lock casing in a direction parallel to solenoid plunger movement. When the lock is subjected to a force or impact, the anti-shock belcrank moves or rotates to a position that will limit the plunger's movement and prevent the mechanical components of the lock from being placed in positions that would permit the lock to be opened. The anti-shock belcrank interacts with the solenoid plunger according to known principles of conservation of momentum.

### BRIEF DESCRIPTION OF THE DRAWINGS

The accompanying drawings incorporated in and forming part of the specification illustrate several aspects of the present invention, and together with the description serve to explain the principles of the invention in the drawings:

FIG. 1 is a rear view of the bolt mechanism of an electronic lock with the lock case removed for clarity showing the mechanical components of the lock.

FIG. 2 is a rear view of the bolt mechanism of FIG. 1, showing the mechanical components not fully reset and subject to unauthorized opening after receiving a shock or impact.

FIG. 3 is a rear view of the bolt mechanism of FIG. 2, showing the position of the anti-shock mechanism after the lock case has been subjected to a shock parallel to the axis of bolt movement.

Reference will be now be made in detail to the present preferred embodiment to the invention, examples of which are illustrated in the accompanying drawings.

### DESCRIPTION OF THE PREFERRED EMBODIMENT

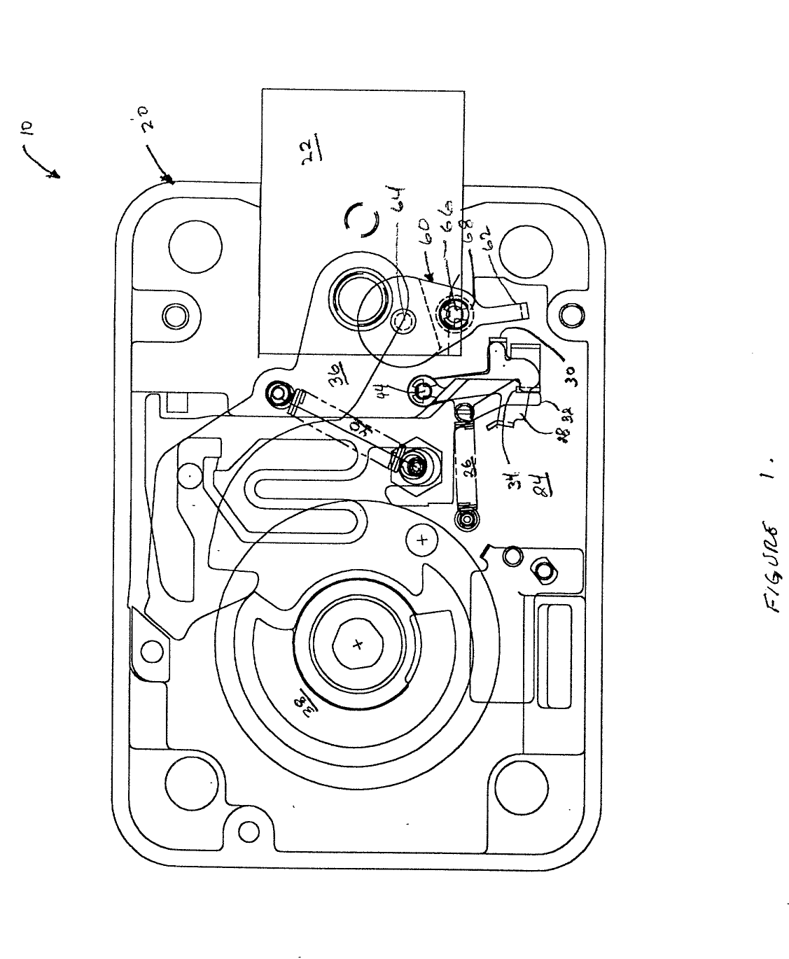

FIG. 1 illustrates the back of one electronic lock 10 that uses a solenoid (not shown) to place the mechanical components in a condition whereby the lock 10 may be opened. The mechanical components are typically located within a lock case 20 that supports a bolt 22 that extends outside of the lock case 20 into a locked position and retracts within the lock case 20 when the lock is opened. The lock 10 may be opened upon entry of the correct combination, followed by energizing the solenoid. Rotation of an external knob (not shown) may be required for some locks.

Once the correct combination is entered, a solenoid (not shown) having a plunger (not shown) is actuated. The solenoid, in the lock case 20 shown, is mounted within the lock case 20 in area 24 with the solenoid plunger moving horizontally upon actuation and may be reset by a return spring 26 or other return system after the solenoid is de-energized.

When the solenoid is actuated, the plunger may contact and then move a knockoff belcrank 28. In the embodiment shown, the knockoff belcrank 28 rotates about pivot 44 when acted upon by the solenoid plunger. Upon rotation, the knockoff belcrank 28 may push latch belcrank 30 away from notch 34 in slider 32. The latch belcrank 30 may also rotate around pivot 44. The slider 32 and lever 36, which is connected by a pin to slider 32, will move in the downward direction when lever 36 is positioned over the cutout in cam 38 under the urging of spring 40.

When the lever 36 moves into the cutout in cam 38, counterclockwise rotation of the cam 38 engages the cam 38 to lever 36 and enables the operator to withdraw bolt 22 that is connected to lever 36 with continued counterclockwise rotation.

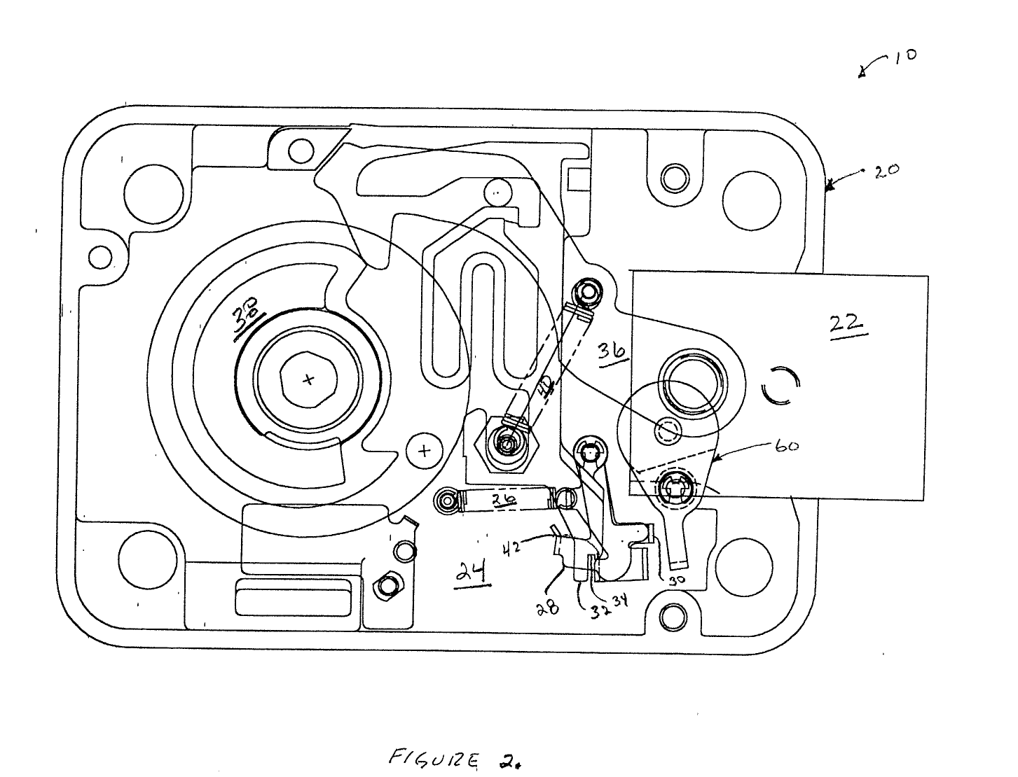

For those embodiments of slider 32 that have a notch 34, FIG. 2 illustrates the need for an anti-shock device of the present invention. With reference now to FIG. 2 showing the slider 32 and lever 36 raised slightly so that the latch belcrank 30 is almost free from notch 34 of slider 32 and resting on knob 42 of slider 32. In this position, the application of an external horizontal force parallel to the direction of bolt retraction may cause the solenoid plunger to push the knockoff belcrank 28 and latch belcrank 30 beyond the control notch 34 on slider 32. Because there is a slight vertical interference between the notch 34 and the latch belcrank 30, the belcranks 28 and 30 will not return to their normal home position after the impact or application of the external force. Thus, the slide 32 is free from control of the latch belcrank 30 and slide 32 together with lever 36 can freely move. Further rotation of the cam wheel 38 will then allow opening lock 10 without actuating the solenoid unless there is an anti-shock mechanism 60 to inhibit movement of the solenoid plunger when an external force or shock is applied.

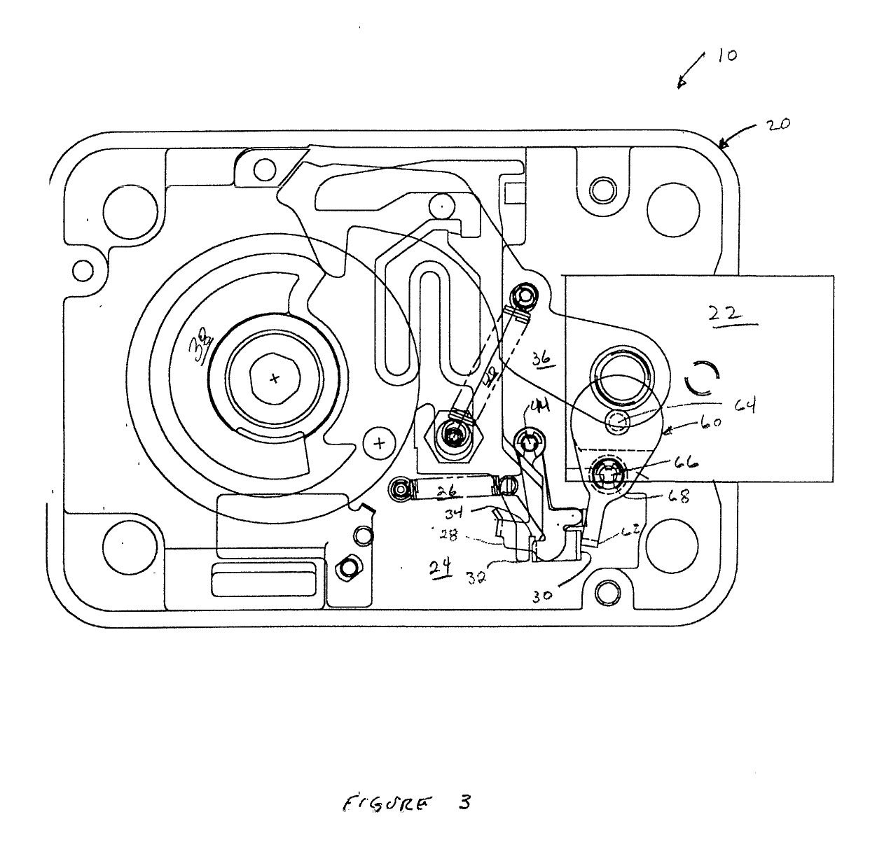

Thus, the need for a lock containing an anti-shock belcrank 60. The embodiment shown has a tip 62 and a center of mass 64 above its pivot point 66. An anti-shock belcrank 60 with the center of mass 64 located above the pivot point 66 rotates with the application of an external impact force to the lock case 20. This same force or impact could cause rotation of the latch belcrank 30 and knockoff belcrank 28. As shown in FIG. 3, the anti-shock belcrank 60 limits the movement of the solenoid plunger and belcranks 28 and 30 by limiting/preventing rotation or movement of either the knockoff belcrank 28 or latch belcrank 30. Through proper design of anti-shock belcrank 60, the displacement of the solenoid plunger may be made arbitrarily small.

The anti-shock belcrank 60 does not influence the movement of the solenoid or solenoid plunger under normal operating conditions of the lock 10 so that the lock 10 may freely open upon entry of the proper predetermined code which actuates the solenoid. Upon actuation, the solenoid plunger of the lock displaces a distance, approximately 0.080 inches with a variance of approximately 0.005 inches in the embodiment shown. For this reason, the anti-shock belcrank 60, for the lock 10 shown is positioned to allow the an initial clearance equal to or larger than that required for normal lock operation between the contacting surfaces of the knockoff belcrank 28 and the anti-shock belcrank 60, a minimum of 0.085 inches is used in the embodiment shown.

The anti-shock belcrank 60 must stop the movement of the solenoid plunger, latch belcrank 30 and knockoff belcrank 28 before the latch belcrank 30 moves beyond the control of notch 34. This occurs, in the lock 10 shown, when the latch belcrank 30 moves approximately 0.03 inches. To maintain the latch belcrank 30 within control of the notch 34 and allow the solenoid to freely move upon actuation, the tip 62 of the anti-shock belcrank 60, in the lock 10 shown, must move approximately 0.055 inches. Thus, the tip 60 of the anti-shock belcrank 60 travels slightly less than twice the distance traveled by the solenoid plunger during impact.

Using known principles of displacement versus time and momentum transfer requirements, the following parameters are established for the anti-shock belcrank 60.

Upon application of an external force, the solenoid plunger, knockoff belcrank 28 and latch belcrank 30 typically move according to the equation:

X=(V/wn)sin wn t+F₀/K(cos wn t−1),

wherein X is the horizontal displacement of the solenoid plunger, the latch belcrank 30 and the knockoff belcrank 28;

V is the velocity of the lock case 20 at impact, if dropped, or experienced if subject to an external force or strike;

wn is the natural frequency of the solenoid plunger, the latch belcrank 30, the knockoff belcrank 28 and return spring system;

t is time to travel distance X;

F₀ is the equivalent initial force of the return spring 26 (the spring force translated to the center of the solenoid contact area); and

K is the equivalent spring rate ratio of the return spring 26 (the spring rate translated to the center of the solenoid contact area).

Upon application of an external force, the anti-shock belcrank typically moves according to the equation:

Xₛₐ=V/wnₛₐ(sin wnₛₐt)+Fₒₛₐ/Kₛₐ(cos wnₛₐt−1),

wherein Xₛₐ is the displacement of the anti-shock belcrank center of mass 64;

V is the velocity of the lock case 20 at impact, if dropped, or experienced if subject to an external force or strike;

wnₛₐ is the natural frequency of the anti-shock belcrank return spring system;

t is time to travel distance Xₛₐ;

Fₒₛₐ is the equivalent initial force of the anti-shock belcrank 60 return spring (the initial force of the anti-shock belcrank return spring translated to the anti-shock belcrank center of mass 64); and

Kₛₐ is the equivalent spring rate of the anti-shock belcrank return spring (the spring rate of the anti-shock belcrank return spring referenced translated to the anti-shock belcrank center of mass).

The solenoid plunger and anti-shock belcrank make contact upon application of an external force by the conservation of momentum equations:

V₁=[(M₁−M₂)/(M₁+M₂)U₁+[(2M₂)/(M₁+M₂)]U₂

V₂=[(2M₁)/(M₁+M₂)]U₁+[(M₂−M₁)(M₁+M₂)]U₂

wherein V₁ is the velocity of the solenoid plunger after impact with the anti-shock belcrank 60;

V₂ is the velocity of the anti-shock belcrank center of mass 64 after impact with the solenoid plunger;

U₁ is the velocity of the solenoid plunger before impact with the anti-shock belcrank 60;

U₂ is the velocity of the anti-shock belcrank center of mass 64 before impact with the solenoid plunger;

M₁ is the mass of the solenoid plunger and the effective mass of both the latch belcrank 30 and the knockoff belcrank 28 referenced to the point on the belcranks where the center of the solenoid plunger contacts the knockoff belcrank 28; and

M₂ is the effective mass ratio of the anti-shock belcrank 60 referenced to the anti-shock belcrank center of mass 64 radius.

When anti-shock belcrank 60 is properly designed, the velocity V₁ will be less than or equal to zero, indicating that the solenoid plunger has stopped or is moving back towards its home position. After the anti-shock belcrank 60 stops rotating, an anti-shock return spring 68 may return the anti-shock belcrank to its home or pre-impact position. The use of an anti-shock return spring 68, while optional, permits the lock 10 to be mounted in any orientation.

In summary, numerous benefits have been described which result from employing the concepts of the invention. The foregoing description of a preferred embodiment of the invention has been presented for the purposes of illustration and description. It is not intended to be exhaustive or to limit the invention to a precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

I claim:

1. A lock comprising:
a lock case;
a solenoid, said solenoid comprising a coil and a plunger, said solenoid residing inside said lock case; and
an anti-shock belcrank, said belcrank pivotally mounted to said lock case, said belcrank positioned so that said belcrank permits said solenoid when energized to place a lock mechanism in a condition where the lock can be opened, and said belcrank prevents said solenoid from placing said lock mechanism in a condition where the lock can be opened when said solenoid is not energized and said lock case is subject to an impact.

2. A lock comprising:
a lock case;
a bolt, said bolt slidably engaging said lock case
a bolt actuator, said actuator extends and retracts said bolt;
a lock mechanism, said lock mechanism is contained within said lock case, said lock mechanism places said actuator in a condition to retract said bolt;
a solenoid, said solenoid comprising a coil and a plunger, said solenoid residing inside said lock case, and when energized said solenoid permits said lock mechanism to operate placing said actuator in a condition to retract said bolt; and
an anti-shock belcrank, said belcrank pivotally mounted to said lock case, said belcrank positioned so that said belcrank permits said solenoid when energized to place a lock mechanism in a condition where said lock can be opened , and said belcrank prevents said solenoid from placing said lock mechanism in a condition where the lock can be opened when said lock case is subject to an impact.
